(19) United States
(12) Patent Application Publication
(10) Pub. No.: US 2025/0288151 A1
(43) Pub. Date: Sep. 18, 2025

(54) OUTDOOR OVEN WITH A SMOKING FUNCTION

(71) Applicant: Zhejiang Shuaishuai Electrical Technology Co., Ltd, Wenzhou (CN)

(72) Inventors: Dechu Huang, Wenzhou (CN); Guojing Chen, Wenzhou (CN)

(21) Appl. No.: 18/633,461

(22) Filed: Apr. 11, 2024

(30) Foreign Application Priority Data
Mar. 18, 2024 (CN) 2024205235483

(51) Int. Cl. A47J 37/06

(52) U.S. Cl. CPC A47J 37/0664; A47J 37/0647

(57) ABSTRACT

The invention relates to the technical field of food cooking devices, in particular to an outdoor oven with a smoking function, which comprises an oven body; the upper cover is provided with a smoke generator, a first air inlet is formed in the middle of the lower end face of the fuel box, the lower end of the fuel box bracket is recessed downward to form a smoke buffer area, an outer cover is formed with a second air inlet corresponding to the smoke buffer area, the smoke buffer area is arranged below the fuel box and communicates with the second air inlet and the first air inlet, this device has the advantage of effectively reducing smoke spillage.

### 1. TECHNICAL FIELD

The invention relates to the technical field of food cooking devices, in particular to an outdoor oven with a smoking function.

### 2. BACKGROUND ART

Outdoor ovens are cooking appliances used for outdoor picnics. To enhance the flavor of food, a smoking function has been added to the oven, imparting a smoky taste to the food, catering to those who enjoy this style.

Chinese utility model patent ZL2022217853459, titled Cooking Assembly and Smoking Assembly, discloses a cooking assembly, comprising a shell, at least one heating element can be arranged in the shell and is in thermal communication with the hollow cooking chamber, and the fan may be arranged in the shell and configured to circulate air in the hollow cooking chamber. The cooking assembly can also comprise a smoking assembly coupled to the shell. The smoking assembly can comprise a fuel box defining an interior chamber in fluid communication with the hollow cooking chamber. The lower region of the fuel box can comprise a second air inlet 56b, the second air inlet 56b aligns with and directly communicates with the first air inlet 56a located on the rear side wall of the shell of the smoking assembly 52. When in use, due to the influence of air flow or excessive smoke volume, smoke will leak out from the first air inlet 56a and the second air inlet 56b.

### 3. SUMMARY OF THE INVENTION

Based on the above problems, the invention provides an outdoor oven with a smoking function. This device has the advantage of effectively reducing smoke spillage.

The object of this invention is achieved in this way:
an outdoor oven with a smoking function comprises an oven body, the oven body comprises a base and an upper cover, the upper cover is rotatably connected to the base, and a cooking space is formed between the base and the upper cover, a baking tray is arranged on the base, the upper cover comprises an outer shell and an inner shell, the outer shell and the inner shell are fixedly connected, an installation gap is arranged between the outer shell and the inner shell, a fixing base for installing a fan motor is arranged on the upper end surface of the inner shell, and the fan motor is installed in the fixing base, the drive shaft of the fan motor extends vertically downward through the inner shell into the cooking space and is connected with fan blades, the fan rotates to generate downward airflow, the drive shaft and the inner shell are sealed by a seal, the inner shell is also provided with a smoke air intake and air exhausts;
the upper cover is also provided with a smoke generator, the smoke generator comprises a fuel box bracket, a fuel box, an igniting rod and a deflector plate, the fuel box bracket is provided with an installation position for accommodating the fuel box, and the fuel box bracket is provided with an opening toward the outer end, the fuel box enters through the opening and is installed in the installation position, the upper end of the fuel box is provided with first smoke outlets, a second smoke outlet communicated with the first smoke outlets is arranged on the upper end surface of the fuel box bracket, the igniting rod is arranged at the upper end of the second smoke outlet;
the fuel box bracket is also provided with the deflector plate, the lower end of the deflector plate is provided with a smoke inlet communicated with the second smoke outlet, the deflector plate is also provided with a smoke outlet communicated with the smoke air intake of the inner shell, the deflector plate is provided with a smoke channel connecting the smoke inlet and the smoke outlet;
a first air inlet is formed in the middle of the lower end face of the fuel box, the lower end of the fuel box bracket is recessed downward to form a smoke buffer area, an outer cover is formed with a second air inlet corresponding to the smoke buffer area, the smoke buffer area is arranged below the fuel box and communicates with the second air inlet and the first air inlet;
the fuel box is provided with an openable sealing cover towards the opening of the fuel box bracket, and the openable outer cover is also arranged at the opening.

A pulling handle is fixed under the fuel box.

The smoke inlet of the deflector plate is provided with a mesh screen.

A fixing plate is arranged above the igniting rod, “W”-shaped fixing pieces are fixed on the lower end surface of the fixing plate, the fixing grooves on both sides of the fixing pieces abut against the lower end surface of the igniting rod to play a fixing and supporting role.

The igniting rod extends toward the side of the fuel box and bends downward to form an “L” shape, a protective cover is arranged on the bent portion of the igniting rod, and the protective cover is fixedly connected to the fuel box bracket.

The inner upper wall of the inner shell is provided with a guide cylinder, the guide cylinder is covered outside the fan, the lower end of the guide cylinder is provided with an airflow outlet, the airflow outlet faces the fan, the sides of the guide cylinder are densely provided with several airflow inlets, the smoke air inlet is arranged on the upper end surface of the inner shell and within the scope of the guide cylinder, the air exhausts are arranged on the rear wall of the inner shell and are arranged outside the scope of the guide cylinder.

A fixing strip of a sealing ring is fixed along the perimeter of the lower end of the inner shell by using screws, an installation gap of the sealing ring is formed between the fixing strip of the sealing ring and the lower end surface of the inner shell, the sealing ring is arranged in this installation gap.

The cross-section of the sealing ring is an “S” shape, which comprises an upper installation part, a lower sealing part, an upper shaping groove and a lower fixing groove, the fixing strip of the sealing ring is stuck in the lower fixing groove, the upper installation part of the sealing ring is squeezed into the installation gap, a circle of shaping ring is set, and the shaping ring is stuck in the upper shaping groove.

A safety switch is arranged on the rear side of the perimeter of the lower end of the inner shell, the shell of the safety switch is fixedly connected to the inner shell, the safety switch is fixed in the shell, a button of the safety switch is arranged on the side, a trigger rod is arranged in the shell, the side of the trigger rod facing the button is provided with a slope, the lower end of the trigger rod passes through the perimeter of the lower end of the inner shell and is pressed against the baking tray.

A spring rod is fixedly connected to the trigger rod, the shell is fixed with a positioning plate, which fits the spring rod, a positioning hole is formed on the positioning plate, the spring rod passes through the positioning hole and moves relative to the positioning hole, a spring is sleeved on the spring rod, the spring is pressed between the positioning plate and the base of the spring rod, and exerts downward force on the trigger rod.

Compared with the existing technology, the invention has outstanding and advantageous technical effects: due to the influence of air flow or the amount of smoke in the fuel box, part of the smoke is not sucked into the cooking space at the first time, this part of the smoke easily overflows from the first air inlet; by the setting of the smoke buffer area, part of the smoke overflowing from the first air inlet can be retained in the smoke buffer area, and then re-sucked from the first air inlet, which can effectively reduce smoke overflow.

### 4. BRIEF DESCRIPTION OF ACCOMPANYING DRAWINGS

In order to more clearly explain the embodiments of the invention or the technical schemes in the prior art, the accompanying drawings that need to be used in the description of the embodiments or the prior art will be briefly introduced below.

FIG. 1 is a schematic diagram 1 of the structure of oven.

FIG. 2 is a schematic diagram 2 of the structure of oven.

FIG. 3 is a schematic diagram of the structure of the oven with the outer shell removed.

FIG. 4 is a schematic diagram of the structure of base.

FIG. 5 is a schematic diagram of the structure of the base with the baking tray removed.

FIG. 6 is a schematic diagram of the structures of the inner shell and the baking tray.

FIG. 7 is a schematic diagram of the structure of the cooking space in the inner shell.

FIG. 8 is a schematic diagram of the structures of the fan, the guide cylinder and the smoke generator.

FIG. 9 is an enlarged view of point A in FIG. 6.

FIG. 10 is a schematic diagram of the structure of the sealing ring.

FIG. 11 is a schematic diagram of the internal structure of the sealing ring.

FIG. 12 is a schematic diagram of the structure of the smoke generator.

FIG. 13 is an explosion diagram 1 of the smoke generator.

FIG. 14 is an explosion diagram 2 of the smoke generator.

FIG. 15 shows the airflow direction in the smoke generator.

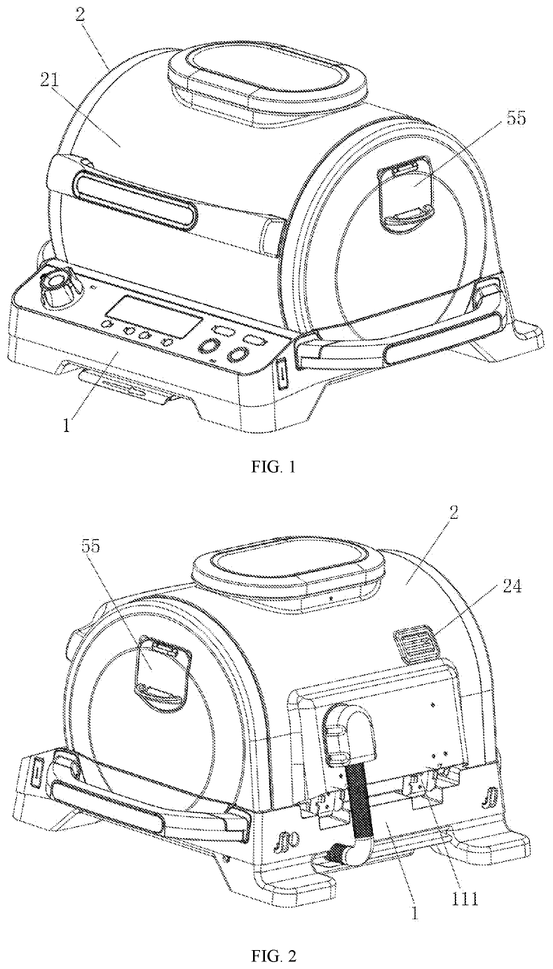

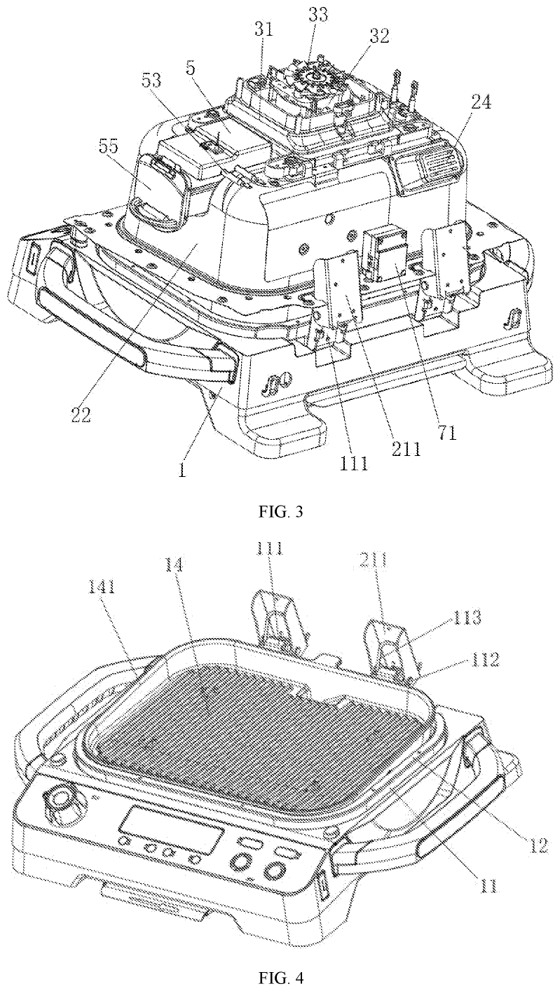

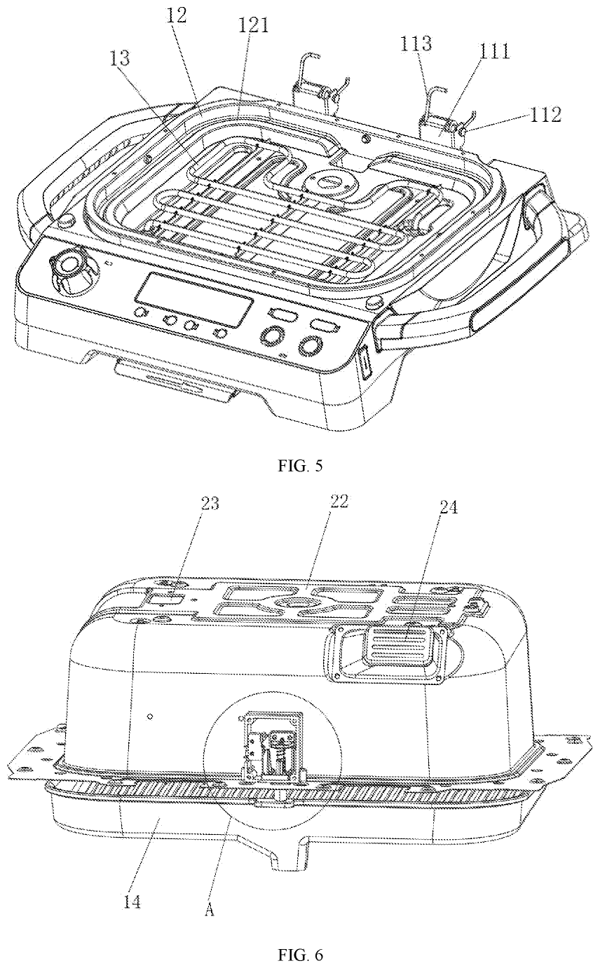

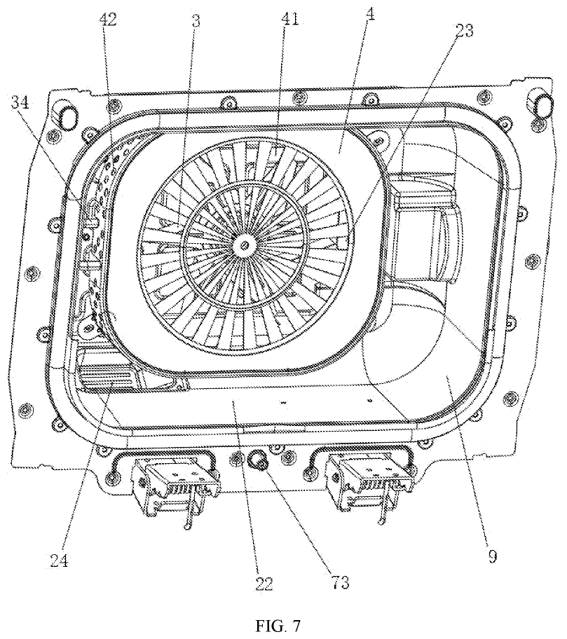

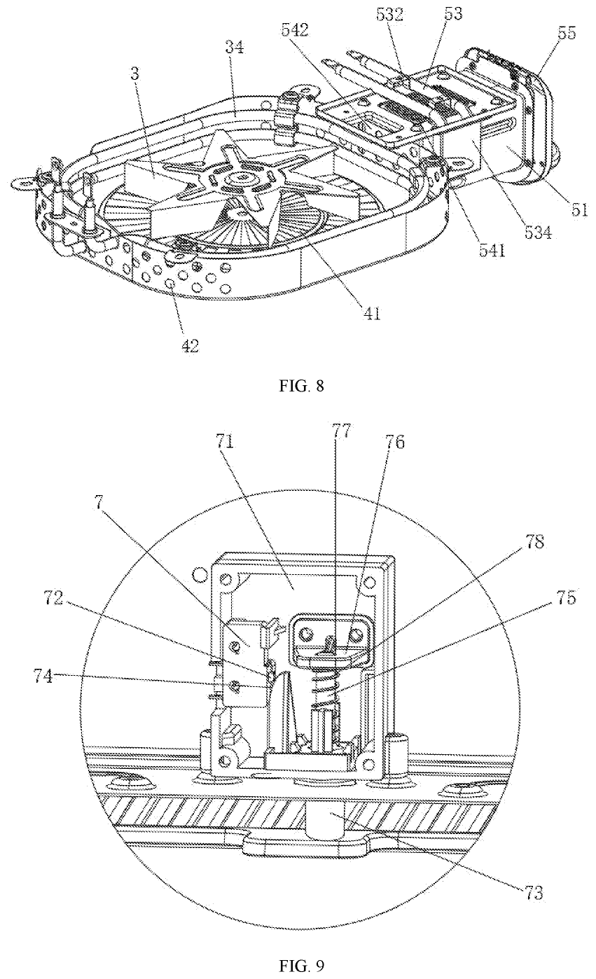

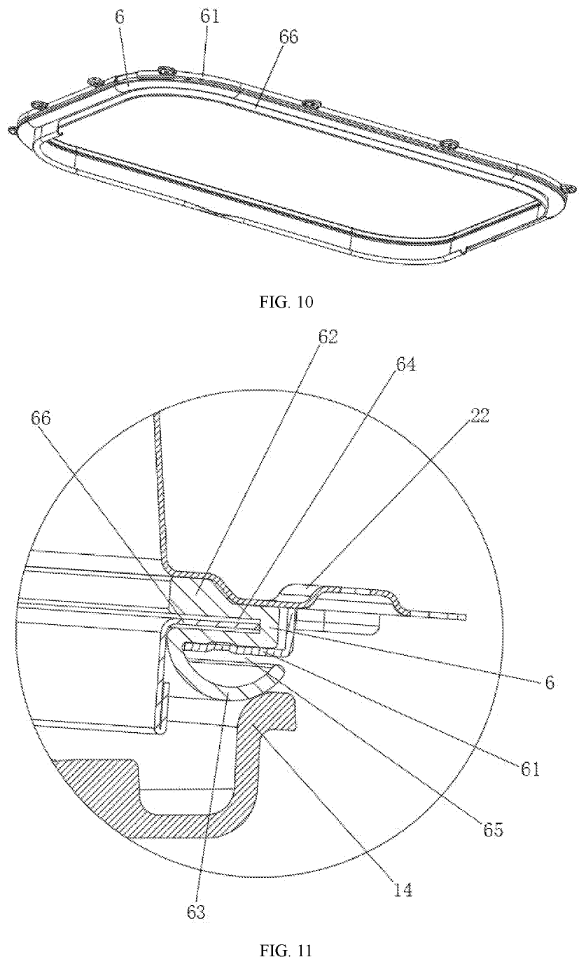

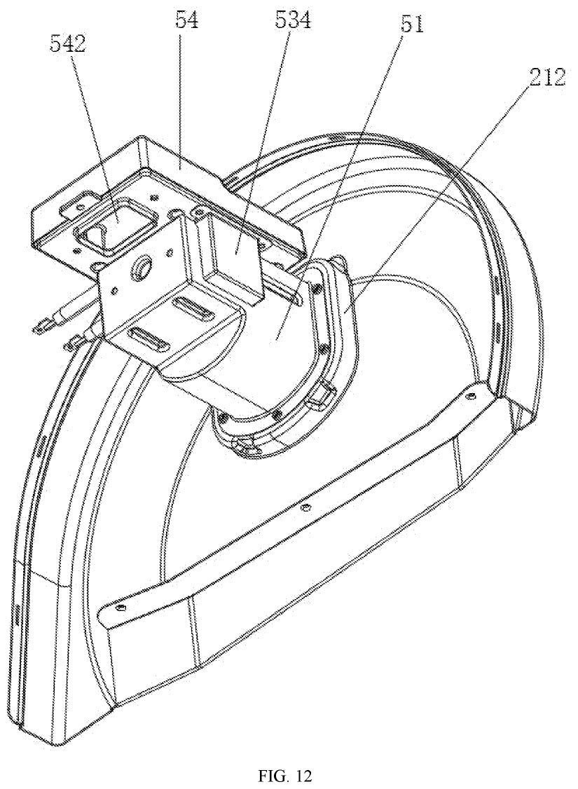

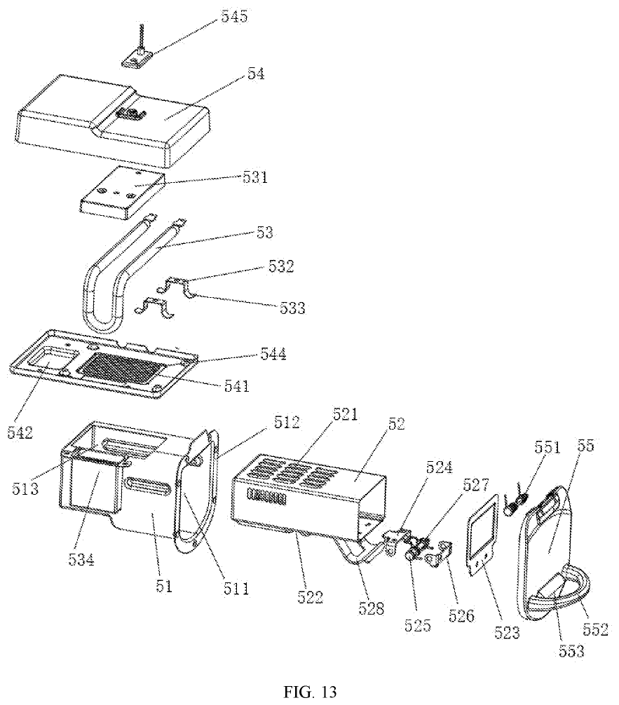

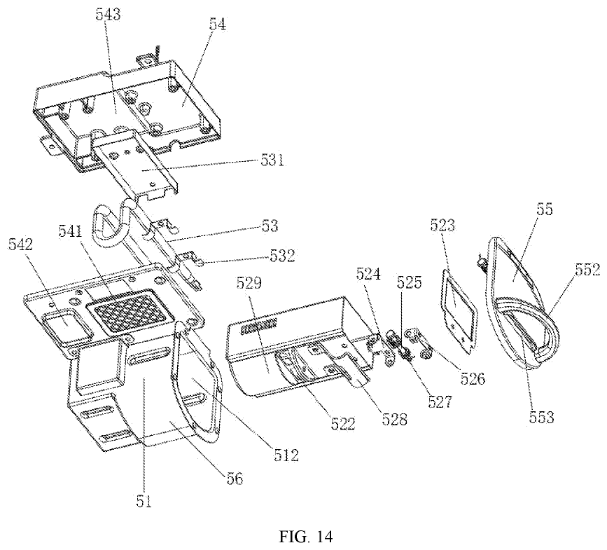

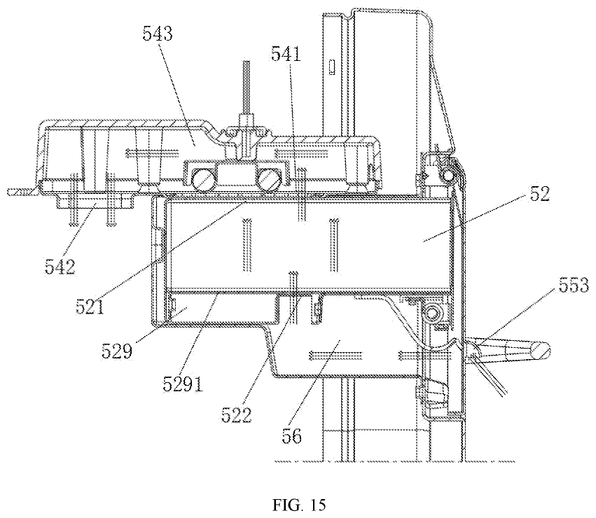

### 5. SPECIFIC EMBODIMENT OF THE INVENTION

In order to make the objects, technical schemes and advantages of the embodiments of the invention clearer, the technical schemes of the invention will be described in detail below. Based on the embodiments of the invention, all other embodiments obtained by those of ordinary skill in the art without any creative work shall fall within the scope protection of the invention.

An outdoor oven with a smoking function comprises an oven body, the oven body comprises a base 1 and an upper cover 2, the rear end of the upper cover 2 is hinged with the base, so that the upper cover 2 is connected to the base 1 in a flippable manner, and a cooking space 9 is formed between the base 1 and the upper cover 2.

A control knob, control buttons and a display panel are arranged on the front of the base 1 for controlling the switch, timing, temperature and other functions of the baking tray and smoke generator.

A fixed base 11 is arranged on the base 1, a fixed plate 12 is arranged in the fixed base, the fixed plate has a concave shape, a heating tube 13 is arranged in the fixed plate 12, a baking tray 14 is arranged on the fixed plate 12, a circle of groove 121 is formed on the inner side of the upper end of the fixed plate 12, the groove matches the perimeter 141 of the baking tray, the perimeter 141 of the baking tray is stuck in the groove 121, a small gap is arranged between baking tray 14 and heating tube 13.

The rear end of the fixed base 11 is fixed with hinge bases 111 through screws, hinge shafts 112 are rotatably arranged on the hinge bases 111, the rear end of the upper cover 2 is rotatably connected to the hinge shafts 112, the hinge shafts 112 are sleeved with torsion springs 113, the torsion springs 113 give the upper cover 2 the force to open, allowing consumers to open the upper cover more easily during use.

The upper cover comprises an outer shell 21 and an inner shell 22, the rear end of the outer shell 21 is fixed with hinge pieces 211, and the hinge pieces 211 are rotationally connected to the hinge shafts 112.

The outer shell 21 and the inner shell 22 are fixedly connected, an installation gap is arranged between the outer shell 21 and the inner shell 22, a fixing base 31 for installing a fan motor is arranged on the upper end surface of the inner shell 22, and the fan motor 32 is installed in the fixing base 31, the drive shaft of the fan motor 32 extends vertically downward through the inner shell into the cooking space 9 and is connected with the fan 3, the fan 3 rotates to generate downward airflow, the drive shaft and the inner shell are sealed by a seal (not shown). The upper end of the fan motor 32 is also provided with motor cooling fan blades 33 for cooling the motor.

An air flow heating tube 34 is arranged on one side of the fan 3.

The inner upper wall of the inner shell 22 is provided with a guide cylinder 4, the guide cylinder 4 is covered outside the fan 3, the lower end of the guide cylinder 4 is provided with an airflow outlet 41, the airflow outlet 41 faces the fan, the sides of the guide cylinder 4 are densely provided with several airflow inlets 42; through the setting of the guide cylinder 4, the air flow in the cooking space 9 is more stable, the wind formed by the rotation of the fan 3 blows downward, this wind blows from the airflow outlet 41 of the guide cylinder 4 to the baking tray 14 below and then spreads around, when it reaches the side of the inner shell 22, it flows upward to the upper part of the inner shell 22, and finally enters from the side airflow inlets 42 of the guide cylinder 4 to achieve a relatively stable airflow circulation. The inner shell 22 is also provided with a smoke air intake 23 and air exhausts 24, the smoke air inlet 23 is arranged on the upper end surface of the inner shell 22 and within the scope of the guide cylinder 4, the air exhausts 24 are arranged on the rear wall of the inner shell 22 and are arranged outside the scope of the guide cylinder 4, the air exhausts 24 are connected to the outer shell and communicate to the outside world.

The guide cylinder 4 and the smoke air intake 23 of the inner shell 22 are arranged within the range of the guide cylinder 4; therefore, the negative pressure generated by the fan 3 can better suck the smoke generated by the smoke generator 5 into the cooking space.

The upper cover 2 is also provided with a smoke generator 5, the smoke generator 5 comprises a fuel box bracket 51, a fuel box 52, an igniting rod 53 and a deflector plate 54, the fuel box bracket 51 is provided with an installation position 511 for accommodating the fuel box 52, and the fuel box bracket 51 is provided with an opening 512 toward the outer end, the fuel box 52 enters or exits through the opening 512, an outer cover 55 is also rotatably connected to the opening 512, the fuel box 52 contains fuel for generating smoke, the upper end of the fuel box 52 is provided with first smoke outlets 521, a second smoke outlet 513 communicated with the first smoke outlets 521 is arranged on the upper end surface of the fuel box bracket 51, the igniting rod 53 is arranged at the upper end of the second smoke outlet 513; the fuel box bracket 51 is also provided with the deflector plate 54, the lower end of the deflector plate 54 is provided with a smoke inlet 541 communicated with the second smoke outlet 513, the deflector plate 54 is also provided with a smoke outlet 542 communicated with the smoke air intake 23 of the inner shell 22, the deflector plate 54 is provided with a smoke channel 543 connecting the smoke inlet 541 and the smoke outlet 542. A first air inlet 522 is formed in the middle of the lower end face of the fuel box 52, the lower end of the fuel box bracket 51 is recessed downward to form a smoke buffer area 56, an outer cover 55 is formed with a second air inlet 553 corresponding to the smoke buffer area 56, the smoke buffer area 56 is arranged below the fuel box 52 and communicates with the second air inlet 553 and the first air inlet 522.

Through the above settings, the overall circulation direction of the airflow in the smoke generator 5 is as follow: the airflow enters from the second air inlet 553, passes through the smoke buffer area 56 and enters the fuel box 52 from the first air inlet 522, then, the smoke generated by igniting the fuel in the fuel box 52 flows out from the first smoke outlets 521, and then flows into the smoke inlet 541 of the deflector plate 54 through the second smoke outlet 513 of the fuel box bracket 51, and passes through the smoke channel 543 inside the deflector plate 54, and enters the cooking space 9 from the smoke outlet 542 through the smoke air intake 23 of the inner shell 22.

Due to the influence of air flow or the amount of smoke in the fuel box 52, part of the smoke is not sucked into the cooking space 9 at the first time, this part of the smoke easily overflows from the first air inlet 522 of the fuel box 52; by the setting of the smoke buffer area 56, part of the smoke overflowing from the first air inlet 522 can be retained in the smoke buffer area 56, and then re-sucked from the first air inlet 522, which can effectively reduce smoke overflow.

The fuel box 52 is provided with an openable sealing cover 523 towards the opening of the fuel box bracket 512, the sealing cover 523 is hinged with the fuel box 52 to realize flip-open lid; specifically, the hinge seat 524 is fixed at the bottom end of the fuel box 52, the hinge seat 524 is provided with a rotating shaft 525, the lower end of the sealing cover 523 is fixed with a hinge 526 and is rotationally connected with the rotating shaft 525, a sealing torsion spring 527 is arranged on the rotating shaft, and the sealing torsion spring 527 gives the sealing cover 523 the pressing force to compress the fuel box to ensure better sealing effect.

A pulling handle 528 is fixed under the fuel box 52, so as to facilitate the user to pull out the fuel box 52 to remove waste materials and reinstall the fuel.

The smoke inlet 541 of the deflector plate 54 is provided with a mesh screen 544.

A fixing plate 531 is arranged above the igniting rod 53, “W”-shaped fixing pieces 532 are fixed on the lower end surface of the fixing plate 531, the fixing grooves 533 on both sides of the fixing pieces 532 abut against the lower end surface of the igniting rod 53 to play a fixing and supporting role. The igniting rod 53 extends toward the side of the fuel box 52 and bends downward to form an “L” shape, a protective cover 534 is arranged on the bent portion of the igniting rod 53, and the protective cover 534 is fixedly connected to the fuel box bracket 51.

A temperature sensor 545 is arranged above the deflector plate 54.

The bottom of the inner side of the fuel box 52 is recessed downward to form an ash collection trough 529, and a filter screen 5291 is arranged on the ash collection trough 529.

The opening 512 of the fuel box bracket 51 is fixedly connected to the outer shell 21, the outer shell 21 is provided with a corresponding through hole 212 to communicate with the opening 512 of the fuel box bracket 51, the outer cover 55 is hinged at the through hole 212, and a torsion spring 551 of the outer cover is provided to allow the outer cover to tightly cover the through hole, a handle 552 is fixed on the outer end of the outer cover 55 to facilitate opening the outer cover 55, the outer cover 55 is the cover of the fuel box bracket 51 and is also the cover of the through hole 212 on the outer shell 21, because the through hole 212 and the opening 512 are interconnected.

A fixing strip of a sealing ring 61 is fixed along the perimeter of the lower end of the inner shell 22 by using screws, an installation gap of the sealing ring is formed between the fixing strip of the sealing ring 61 and the lower end surface of the inner shell for installing the sealing ring 6. Specifically, the cross-section of the sealing ring 6 is an “S” shape, which comprises an upper installation part 62, a lower sealing part 63, an upper shaping groove 64 and a lower fixing groove 65, the fixing strip of the sealing ring 61 is stuck in the lower fixing groove 65, the upper installation part 62 of the sealing ring 6 is squeezed into the installation gap, a circle of shaping ring 66 is set, and the shaping ring 66 is stuck in the upper shaping groove 64 to prevent the sealing ring 6 from retracting and detaching, the lower sealing part 63 of the sealing ring 6 abuts the inside of the upper perimeter of the baking tray to achieve sealing at the opening between the upper cover 2 and the base 1.

A safety switch 7 is arranged on the rear side of the perimeter of the lower end of the inner shell 22, the shell of the safety switch 71 is fixedly connected to the inner shell 22, the safety switch 7 is fixed in the shell 71, a button of the safety switch 72 is arranged on the side, a trigger rod 73 is arranged in the shell 71, the side of the trigger rod 73 facing the button 72 is provided with a slope 74, the lower end of the trigger rod 73 passes through the perimeter of the lower end of the inner shell and is pressed against the baking tray 14; when the upper cover 2 is closed, the trigger rod 73 will not touch the button 72 due to the existence of the slope 74; when the upper cover 2 is opened, because the lower end of the trigger rod 73 abuts against the baking tray 14, the baking tray 14 moves upward against the trigger rod 73 relative to the button 72, the lower end of the slope 74 touches the button 72, and the safety switch 7 controls the oven to stop operation.

A spring rod 75 is fixedly connected to the trigger rod 73, the shell 71 is fixed with a positioning plate 76, which fits the spring rod 75, a positioning hole 77 is formed on the positioning plate 76, the spring rod 75 passes through the positioning hole 77 and moves relative to the positioning hole 77, a spring 78 is sleeved on the spring rod 75, the spring 78 is pressed between the positioning plate 76 and the base of the spring rod 75, and exerts downward force on the trigger rod 73; when the upper cover 2 is closed, the spring 78 pushes the trigger rod 73 downward to reset, and the trigger rod 73 separates from the button 72 through the slope 74, so that the oven can resume operation.

The invention has the characteristic of effectively reducing smoke spillage.

The above embodiments are only preferred embodiments of the invention and do not limit the protection scope of the invention. Therefore, any equivalent changes made based on the structure, shape, and principle of the invention shall be covered by the protection scope of the invention.

1. An outdoor oven with a smoking function comprises an oven body, the oven body comprises a base and an upper cover, the upper cover is rotatably connected to the base, and a cooking space is formed between the base and the upper cover, a baking tray is arranged on the base, the upper cover comprises an outer shell and an inner shell, the outer shell and the inner shell are fixedly connected, an installation gap is arranged between the outer shell and the inner shell, a fixing base for installing a fan motor is arranged on the upper end surface of the inner shell, and the fan motor is installed in the fixing base, the drive shaft of the fan motor extends vertically downward through the inner shell into the cooking space and is connected with fan blades, the fan rotates to generate downward airflow, the drive shaft and the inner shell are sealed by a seal, the inner shell is also provided with a smoke air intake and air exhausts;
the upper cover is also provided with a smoke generator, the smoke generator comprises a fuel box bracket, a fuel box, an igniting rod and a deflector plate, the fuel box bracket is provided with an installation position for accommodating the fuel box, and the fuel box bracket is provided with an opening toward the outer end, the fuel box enters through the opening and is installed in the installation position, the upper end of the fuel box is provided with first smoke outlets, a second smoke outlet communicated with the first smoke outlets is arranged on the upper end surface of the fuel box bracket, the igniting rod is arranged at the upper end of the second smoke outlet;
the fuel box bracket is also provided with the deflector plate, the lower end of the deflector plate is provided with a smoke inlet communicated with the second smoke outlet, the deflector plate is also provided with a smoke outlet communicated with the smoke air intake of the inner shell, the deflector plate is provided with a smoke channel connecting the smoke inlet and the smoke outlet;
a first air inlet is formed in the middle of the lower end face of the fuel box, the lower end of the fuel box bracket is recessed downward to form a smoke buffer area, an outer cover is formed with a second air inlet corresponding to the smoke buffer area, the smoke buffer area is arranged below the fuel box and communicates with the second air inlet and the first air inlet;
the fuel box is provided with an openable sealing cover towards the opening of the fuel box bracket, and the openable outer cover is also arranged at the opening.

2. The outdoor oven with a smoking function of claim 1, a pulling handle is fixed under the fuel box.

3. The outdoor oven with a smoking function of claim 1, the smoke inlet of the deflector plate is provided with a mesh screen.

4. The outdoor oven with a smoking function of claim 1, a fixing plate is arranged above the igniting rod, “W”-shaped fixing pieces are fixed on the lower end surface of the fixing plate, the fixing grooves on both sides of the fixing pieces abut against the lower end surface of the igniting rod to play a fixing and supporting role.

5. The outdoor oven with a smoking function of claim 4, the igniting rod extends toward the side of the fuel box and bends downward to form an “L” shape, a protective cover is arranged on the bent portion of the igniting rod, and the protective cover is fixedly connected to the fuel box bracket.

6. The outdoor oven with a smoking function of claim 1, the inner upper wall of the inner shell is provided with a guide cylinder, the guide cylinder is covered outside the fan, the lower end of the guide cylinder is provided with an airflow outlet, the airflow outlet faces the fan, the sides of the guide cylinder are densely provided with several airflow inlets, the smoke air inlet is arranged on the upper end surface of the inner shell and within the scope of the guide cylinder, the air exhausts are arranged on the rear wall of the inner shell and are arranged outside the scope of the guide cylinder.

7. The outdoor oven with a smoking function of claim 1, a fixing strip of a sealing ring is fixed along the perimeter of the lower end of the inner shell by using screws, an installation gap of the sealing ring is formed between the fixing strip of the sealing ring and the lower end surface of the inner shell, the sealing ring is arranged in this installation gap.

8. The outdoor oven with a smoking function of claim 7, the cross-section of the sealing ring is an “S” shape, which comprises an upper installation part, a lower sealing part, an upper shaping groove and a lower fixing groove, the fixing strip of the sealing ring is stuck in the lower fixing groove, the upper installation part of the sealing ring is squeezed into the installation gap, a circle of shaping ring is set, and the shaping ring is stuck in the upper shaping groove.

9. The outdoor oven with a smoking function of claim 8, a safety switch is arranged on the rear side of the perimeter of the lower end of the inner shell, the shell of the safety switch is fixedly connected to the inner shell, the safety switch is fixed in the shell, a button of the safety switch is arranged on the side, a trigger rod is arranged in the shell, the side of the trigger rod facing the button is provided with a slope, the lower end of the trigger rod passes through the perimeter of the lower end of the inner shell and is pressed against the baking tray.

10. The outdoor oven with a smoking function of claim 9, a spring rod is fixedly connected to the trigger rod, the shell is fixed with a positioning plate, which fits the spring rod, a positioning hole is formed on the positioning plate, the spring rod passes through the positioning hole and moves relative to the positioning hole, a spring is sleeved on the spring rod, the spring is pressed between the positioning plate and the base of the spring rod, and exerts downward force on the trigger rod.
